(19) United States
(12) Patent Application Publication
(10) Pub. No.: US 2018/0082584 A1
(43) Pub. Date: Mar. 22, 2018

(54) TRAFFIC LIGHTS PROBLEMS NOTIFICATION

(71) Applicant: Panasonic Automotive Systems Company of America, Division of Panasonic Corporation of North America, PEACHTREE CITY, GA (US)

(72) Inventors: SHANTHA KUMARI RAJENDRAN, FARMINGTON HILLS, MI (US); MEENA RUKMANKATHA RAJAN, MARIETTA, GA (US)

(73) Assignee: Panasonic Automotive Systems Company of America, Division of Panasonic Corporation of North America

(21) Appl. No.: 15/710,470

(22) Filed: Sep. 20, 2017

Related U.S. Application Data
(60) Provisional application No. 62/398,019, filed on Sep. 22, 2016.

(51) Int. Cl. G08G 1/0962; G08G 1/096; G08G 1/0967; G08G 1/09

(52) U.S. Cl. CPC G08G 1/09623; G08G 1/091; G08G 1/096783; G08G 1/096

(57) ABSTRACT

A motor vehicle includes a user interface having a display screen and a loudspeaker. A radio frequency receiver receives a wireless status signal from a traffic light. An electronic processor is communicatively coupled to the radio frequency receiver and determines whether to present content from the status signal to a driver of the vehicle. If it is determined to present content from the status signal to the driver, the content is presented via the display screen and/or the loudspeaker.

### CROSS-REFERENCE TO RELATED APPLICATION

This application claims benefit of U.S. Provisional Application No. 62/398,019 filed on Sep. 22, 2016, which the disclosure of which is hereby incorporated by reference in its entirety for all purposes.

### BACKGROUND OF THE INVENTION

### 1. Field of the Invention

The present invention relates to notifying drivers about the statuses of traffic lights.

### 2. Description of the Related Art

Drivers sometimes cannot see traffic lights soon enough to make safe decisions in view of the color of the traffic light. Drivers are also sometimes not focused enough on traffic lights in order to make prompt and safe decisions.

There are some smart phone apps that provide count down notification about traffic lights. But there is no in-vehicle application that provides chimes, warning texts and/or icon displays to the driver.

### SUMMARY OF THE INVENTION

The invention may provide an in-vehicle apparatus that notifies vehicle drivers about the statuses of traffic lights and that helps the drivers in driving safely and making prompt driving decisions. An electronic processor within the vehicle may communicate wirelessly with the electronic controllers of traffic lights. The inventive apparatus may notify drivers about problems with traffic lights that the driver's vehicles are approaching. For example, the inventive apparatus may notify the driver that an upcoming light is not working properly, and that the driver should proceed with caution. The inventive apparatus may also notify the driver that an upcoming light is about to turn color (e.g., to red, yellow or green) by, for example, presenting an audible chime, a visible icon display, a visible warning text, and/or a numeric time count down (audible and/or visible) until the color change. The inventive apparatus may further notify the driver that an all-way-stop type of traffic light is being approached by presenting a warning text, a numeric time count down (audible and/or visible) count down until the light is reached and/or until the driver may proceed through the light, an audible spoken warning, and/or a chime sound. Lastly, the inventive apparatus may notify the driver that a four-way junction is being approached. When the vehicle is about to turn left across oncoming traffic, as indicated by a turn signal or planned navigation route, and the oncoming traffic has a green light, the inventive apparatus may notify the driver that the oncoming vehicles have the right of the way.

The invention comprises, in one form thereof, a motor vehicle including a user interface having a display screen and a loudspeaker. A radio frequency receiver receives a wireless status signal from a traffic light. An electronic processor is communicatively coupled to the radio frequency receiver and determines whether to present content from the status signal to a driver of the vehicle. If it is determined to present content from the status signal to the driver, the content is presented via the display screen and/or the loudspeaker.

The invention comprises, in another form thereof, a traffic light notification method for a motor vehicle, including permanently installing within the motor vehicle a user interface including a display screen and a loudspeaker. A radio frequency receiver is permanently installed within the motor vehicle. The radio frequency receiver is used to receive a wireless status signal from a traffic light. It is determined whether to present content from the status signal to a driver of the vehicle. If it is determined to present content from the status signal to a driver, then the content is presented to the driver via the display screen and/or the loudspeaker.

The invention comprises, in yet another form thereof, a motor vehicle including a user interface having a display screen and a loudspeaker. A radio frequency receiver receives a wireless status signal from a traffic light. An electronic processor is communicatively coupled to the radio frequency receiver. The electronic processor indicates the content to a driver of the motor vehicle via an audible chime on the loudspeaker, a visible icon on the display screen, a visible text on the display screen, an audible spoken message on the loudspeaker, and/or a numeric time count down presented on the loudspeaker and/or on the display screen.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a block diagram of one embodiment of a traffic light notification arrangement of the present invention.

FIG. 2 is a flow chart of one embodiment of a traffic light notification method of the present invention for a motor vehicle.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

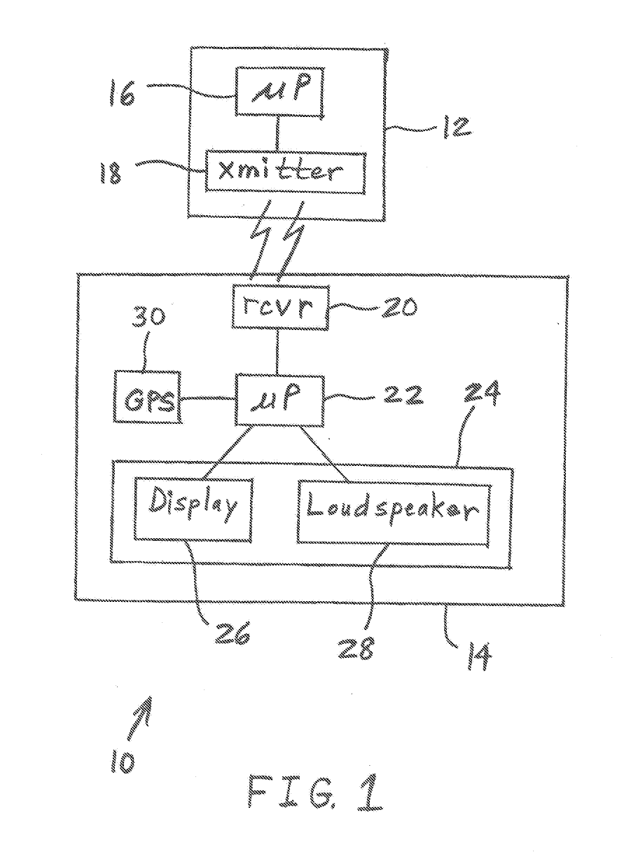

FIG. 1 illustrates one embodiment of a traffic light notification arrangement 10 of the present invention including a traffic light 12 and a vehicle 14. Traffic light 12 includes an electronic controller 16 and a transmitter 18 that wirelessly transmits information about which light (e.g., the red light, yellow light or green light, which may be a round light or an arrow) is currently ON, which light will be ON next, and/or how much time will elapse before the next light is turned ON.

Vehicle 14 includes a receiver 20, an electronic processor 22, a user interface 24 having a display screen 26 and an audio loudspeaker 28, and a global positioning system (GPS) 30.

During use, transmitter 18 may transmit wireless frequency signals indicating geographical coordinates of traffic light 12; the cardinal direction in which traffic light 12 is facing; what color and what type (e.g., round or arrow) of light that is currently ON within traffic light 12; what color and what type of light will next be ON within traffic light 12; and the length of time remaining until the light changes to the next color and/or type of light being ON.

Receiver 20 receives the signal transmitted by transmitter 18 and transmits the signal to processor 22. Processor 22 analyzes the signal and decides whether to communicate the signal to the driver. For example, processor 22 may not communicate the signal to the driver if GPS 30 indicates that vehicle 10 will not arrive at traffic light 12 within a threshold period of time, given the current and/or estimated future speed of vehicle 10. As another example, some signals received by receiver 20 may be from a traffic light that vehicle 10 is not heading toward, or is not facing vehicle 10, and processor 22 may choose not to communicate these signals to the driver.

If processor 22 does decide to communicate the signal to the driver, then processor 22 may present an indication of the signal to the driver via user interface 24. For example, processor 22 may present an indication of the signal to the driver via an audible chime on loudspeaker 28, a visible icon on display screen 26, a visible warning text on display screen 26, an audible spoken warning on loudspeaker 28, and/or a numeric time count down (audible and/or visible). The indication of the signal may indicate to the driver that the upcoming traffic light is malfunctioning; a time and/or distance before the traffic light will be reached; the color and/or type of light that is currently in effect; an amount of time remaining before the color and/or type of light changes; and/or that traffic from another direction has the right-of-way in the intersection associated with the traffic light.

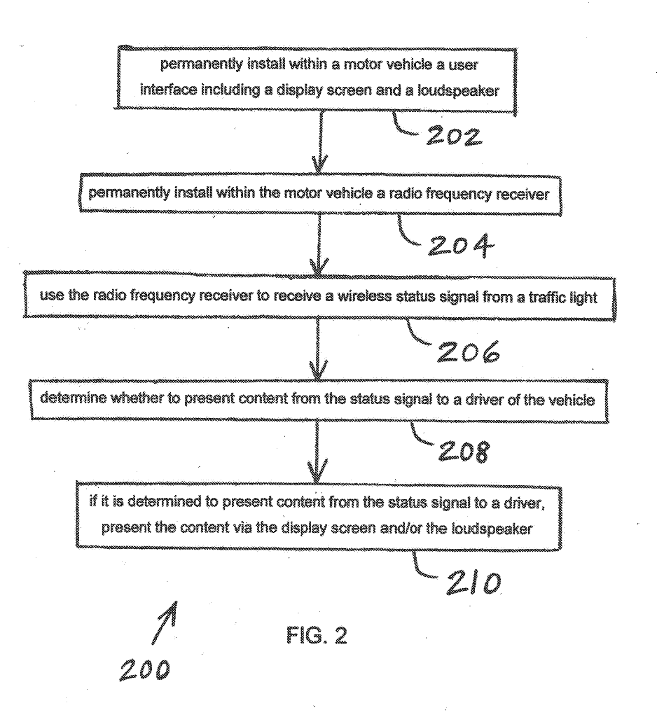

FIG. 2 is a flow chart of one embodiment of a traffic light notification method 200 of the present invention for a motor vehicle. In a first step 202, a user interface, including a display screen and a loudspeaker, is permanently installed within the motor vehicle. For example, user interface 24, including display screen 26 and loudspeaker 28, is permanently installed within motor vehicle 14.

In a next step 204, a radio frequency receiver is permanently installed within the motor vehicle. For example, radio frequency receiver 20 is permanently installed within motor vehicle 14.

Next, in step 206, the radio frequency receiver is used to receive a wireless status signal from a traffic light. For example, radio frequency receiver 20 is used to receive a wireless status signal from traffic light 12.

In step 208, it is determined whether to present content from the status signal to a driver of the vehicle. For example, processor 22 may not present the content from the status signal to the driver if the speed of vehicle 10 indicates that vehicle 10 will not arrive at traffic light 12 within a threshold period of time, given the current distance between vehicle 10 and traffic light 12. As another example, some signals received by receiver 20 may be from a traffic light that is not the next traffic light that vehicle 10 will encounter, and processor 22 may choose not to communicate these signals to the driver.

In a final step 210, if it is determined to present content from the status signal to a driver, the content is presented via the display screen and/or the loudspeaker. For example, processor 22 may present an indication of the signal to the driver via an audible chime on loudspeaker 28, a visible icon on display screen 26, a visible warning text on display screen 26, an audible spoken warning on loudspeaker 28, and/or a numeric time count down (audible and/or visible).

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A motor vehicle, comprising:
a user interface including a display screen and a loudspeaker,
a radio frequency receiver configured to receive a wireless status signal from a traffic light;
an electronic processor communicatively coupled to the radio frequency receiver and configured to:
determine whether to present content from the status signal to a driver of the vehicle; and
if it is determined to present content from the status signal to a driver, present the content via the display screen and/or the loudspeaker.

2. The motor vehicle of claim 1, wherein the electronic processor is configured to present the content via an audible chime on the loudspeaker.

3. The motor vehicle of claim 1, wherein the electronic processor is configured to present the content via a visible icon on the display screen;

4. The motor vehicle of claim 1, wherein the electronic processor is configured to present the content via a visible text on the display screen.

5. The motor vehicle of claim 1, wherein the electronic processor is configured to present the content via an audible spoken message on the loudspeaker.

6. The motor vehicle of claim 1, wherein the electronic processor is configured to present the content via a numeric time count down presented on the loudspeaker and/or on the display screen.

7. The motor vehicle of claim 1, further comprising a global positioning system communicatively coupled to the electronic processor, the electronic processor being configured to determine whether to present content from the status signal to a driver of the vehicle dependent upon a distance between the traffic light and the motor vehicle.

8. The motor vehicle of claim 1, wherein the electronic processor is configured to determine whether to present content from the status signal to a driver of the vehicle dependent upon an estimated time before the motor vehicle reaches the traffic light.

9. The motor vehicle of claim 1, wherein the electronic processor is configured to determine whether to present content from the status signal to a driver of the vehicle dependent upon a first direction in which the traffic light is facing and a second direction in which the motor vehicle is traveling.

10. A traffic light notification method for a motor vehicle, the method comprising:
permanently installing within the motor vehicle a user interface including a display screen and a loudspeaker;
permanently installing within the motor vehicle a radio frequency receiver;
using the radio frequency receiver to receive a wireless status signal from a traffic light;
determining whether to present content from the status signal to a driver of the vehicle; and
if it is determined to present content from the status signal to a driver, presenting the content via the display screen and/or the loudspeaker.

11. The method of claim 10, wherein the content is presented via an audible chime played on the loudspeaker.

12. The method of claim 10, wherein the content is presented via a visible icon on the display screen.

13. The method of claim 10, wherein the content is presented via a visible text on the display screen.

14. The method of claim 10, wherein the content is presented via an audible spoken message on the loudspeaker.

15. The method of claim 10, wherein the content is presented via a numeric time count down on the loudspeaker and/or on the display screen.

16. The method of claim 10, wherein the determining includes determining whether to present content from the status signal to a driver of the vehicle dependent upon a distance between the traffic light and the motor vehicle.

17. The method of claim 10, wherein the determining includes determining whether to present content from the status signal to a driver of the vehicle dependent upon an estimated time before the motor vehicle reaches the traffic light.

18. The method of claim 10, wherein the determining includes determining whether to present content from the status signal to a driver of the vehicle dependent upon a first direction in which the traffic light is facing and a second direction in which the motor vehicle is traveling.

19. A motor vehicle, comprising:
a user interface including a display screen and a loudspeaker;
a radio frequency receiver configured to receive a wireless status signal from a traffic light; and
an electronic processor communicatively coupled to the radio frequency receiver and configured to indicate the content to a driver of the motor vehicle via at least one of:
an audible chime on the loudspeaker;
a visible icon on the display screen;
a visible text on the display screen;
an audible spoken message on the loudspeaker; and
a numeric time count down presented on the loudspeaker and/or on the display screen.

20. The motor vehicle of claim 19 wherein the electronic processor is configured to indicate the content to a driver of the motor vehicle only if the traffic light is facing the driver and the motor vehicle is within a threshold distance or travel time of the traffic light.
